(19) United States
(12) Patent Application Publication
(10) Pub. No.: US 2008/0009266 A1
(43) Pub. Date: Jan. 10, 2008

(54) Communication Device, Wireless Network, Program, And Storage Medium

(75) Inventors: Yuji Yamasaki, Pasadena, CA (US); Hirofumi Torigai, Setagaya-ku (JP); Satoshi Kondo, Tokorozawa-shi (JP); Masaki Fukumoto, Suginami-ku (JP); Mamoru Tomita, Mitaka-shi (JP)

Correspondence Address: OLIFF & BERRIDGE, PLC, P.O. BOX 320850, ALEXANDRIA, VA, 22320-4850, US

(73) Assignee: Trend Micro Incorporated, Shibuya-ku, TOKYO (JP)

(21) Appl. No.: 11/629,851

(22) PCT Filed: Jun. 17, 2005
(86) PCT No.: PCT/JP05/11574

§ 371 Date: Dec. 18, 2006

(30) Foreign Application Priority Data
Jun. 21, 2004 (JP) 2004-182955

(51) Int. Cl. H04M 1/66

(52) U.S. Cl. 455/411

(57) ABSTRACT

The present invention provides a technique of enabling communication devices constituting a wireless network to register and update identification information easily, and thereby ensuring security of the communication devices and the wireless network and of detecting a communication device suspected of accessing a wireless network illegally and informing a user of the communication device. Communication terminal 20b detects and reports networked devices constituting wireless LAN 1, and if communication with the reported networked devices is permitted through an operation of operating unit 204, registers the MAC addresses of the networked devices in permission table 206a. Communication terminal 20b permits communication with a networked device constituting wireless LAN 1 whose MAC address has been registered in permission table 206a, and prohibits communication with a networked device constituting wireless LAN 1 whose MAC address has not been registered in permission table 206a.

### TECHNICAL FIELD

The present invention relates to a technique of ensuring security of a communication device and a wireless network.

### BACKGROUND ART

In recent years, a wireless LAN has become popular not only for office use but also for home use. This is partly attributable to an advantage of a wireless LAN wherein it is unnecessary for devices such as a computer or printer to be connected by a communication cable in order to be operable. However, in a wireless LAN, since data are exchanged wirelessly, it is relatively easy as compared with a cable connected LAN, for a hacker to gain unauthorized access to a network and at the same time remain undetected. An unauthorized access to a wireless LAN for example, would involve the use of a communication device, whose identity is concealed, for breaking into a wireless LAN in order to steal data stored in a device or exchanged between devices connected to the wireless LAN, or for accessing another communication network via the invaded wireless LAN.

To address the above-mentioned problem of security in a wireless LAN system, JP2003-046533 discloses a network system wherein a switching hub makes an inquiry at an authentication server regarding a MAC address of a communication device when a communication request is received by the switching hub. At the authentication server, MAC addresses of all communication terminals that are permitted to carry out communication via a network are registered. If the MAC address of the communication device making a communication request has been registered at the authentication server, the switching hub registers the MAC address and a port number in a MAC address table, and transfers the communication request and subsequent frames from the communication device to a router. On the other hand, if the MAC address of the communication device has not been registered at the server, the switching hub registers the MAC address in a MAC address filter, and discards the communication request and subsequent frames from the communication device.

Also, JP2003-110570 discloses a CATV system wherein a wireless cable modem relays communication between a wireless terminal and a center device. The wireless cable modem registers therein, MAC addresses of wireless terminals which are permitted to use the wireless cable modem, and denies an access from a wireless terminal whose MAC address has not been registered. Also, JP2003-309569 discloses a DHCP server which determines whether a MAC address of a client terminal requesting assignment of an IP address has been registered in a MAC address management table of the DHCP server, and if the MAC address has not been registered, denies the assigning of an IP address to the client terminal, and thereby preventing an unauthorized access.

In the arts disclosed in the above references, MAC addresses of network devices permitted to carry out communication are pre-registered, and only a device whose MAC address has been pre-registered is permitted to perform communication through a wireless LAN. Accordingly, it is necessary to pre-store MAC addresses of all network devices that are permitted to carry out communication which can be cumbersome. Additionally, in a public wireless LAN, since there is a large turnover of communication terminals served therein, each time a new device is added to the public wireless LAN, an operator needs to update a data table of registered MAC addresses when a new MAC address is added thereto, which operation can be cumbersome. If the registration and update operations are neglected, smooth communication between devices connected to a wireless LAN is impeded.

The present invention has been made in view of the problems discussed above, and provides a technique of enabling a communication device constituting a wireless network to register and update identification information easily, and thereby ensuring security of the communication device and the wireless network, and of detecting a communication device suspected of accessing a wireless network illegally and informing the user of the communication device.

### DISCLOSURE OF INVENTION

To solve the problems, the present invention provides a communication device comprising: detecting means for detecting a communication device constituting a wireless network; reporting means for reporting information on a communication device detected by the detecting means; operating means; registering means, if communication with a communication device reported by the reporting means is permitted through an operation of the operating means, for registering identification information of the communication device in memory; monitoring means for monitoring the wireless network and detecting a communication device constituting the wireless network whose identification information has not been registered in the memory; warning means for warning of a suspected unauthorized access in addition to reporting information on a communication device detected by the monitoring means; updating means, if communication with a communication device reported by the warning means is permitted through an operation of the operating means, for registering identification information on the communication device in the memory additionally; and communication controlling means for permitting communication with a communication device constituting the wireless network whose identification information has been registered in the memory, and for prohibiting communication with a communication device constituting the wireless network whose identification information has not been registered in the memory.

The present invention also provides a program for causing a computer to execute: a first step of detecting a communication device constituting a wireless network; a second step of reporting information of a communication device detected in the first step; a third step, if communication with a communication device reported in the second step is permitted through an operation of the operating means, of registering identification information of the communication device in memory; a fourth step of monitoring the wireless network and detecting a communication device constituting the wireless network whose identification information has not been registered in the memory; a fifth step of warning of a suspected unauthorized access in addition to reporting information on a communication device detected in the fourth step; a sixth step, if communication with a communication device reported in the fifth step is permitted through an operation of operating means, of registering identification information of the communication device in the memory additionally; and a seventh step of permitting communication with a communication device constituting the wireless network whose identification information has been registered in the memory, and of prohibiting communication with a communication device constituting the wireless network whose identification information has not been registered in the memory. The present invention also provides a computer-readable storage medium recording the program.

According to the present embodiment, a communication terminal (computer) detects and reports networked devices constituting a wireless network, and if communication with the reported networked devices are permitted, registers the MAC addresses of the networked devices in memory. Also, the communication terminal monitors the wireless network, detects an unknown networked device whose MAC address has not been registered in the memory, and warns of a suspected unauthorized access. If communication with the detected networked device is permitted, the communication terminal registers the MAC address of the networked device in the memory additionally. Also, the communication terminal permits communication to be carried out with a networked device constituting the wireless network whose MAC address has been registered in the memory, and prohibits the carrying out of communication with a networked device constituting the wireless network whose MAC address has not been registered in the memory.

The present invention also provides a communication device comprising: detecting means for detecting a communication device constituting a wireless network; reporting means for reporting information on a communication device detected by the detecting means; operating means; registering means, if communication with a communication device reported by the reporting means is permitted or not permitted through an operation of the operating means, for registering identification information of the communication device in a first table when the communication is permitted, and for registering the identification information of the communication device in a second table when the communication is not permitted; monitoring means for monitoring the wireless network and detecting a communication device constituting the wireless network whose identification information has not been registered in either the first table or the second table; warning means for warning of a suspected unauthorized access in addition to reporting information on a communication device detected by the monitoring means; updating means, if communication with a communication device reported by the warning means is permitted or not permitted through an operation of the operating means, for registering identification information of the communication device in a first table additionally when the communication is permitted, and for registering the identification information of the communication device in a second table additionally when the communication is not permitted; and communication controlling means for permitting communication with a communication device constituting the wireless network whose identification information has been registered in the first table, and for prohibiting communication with a communication device constituting the wireless network whose identification information has been registered in the second table or a communication device constituting the wireless network whose identification information has not been registered in either the first table or the second table.

The program may be configured to cause a computer to execute: a first step of detecting a communication device constituting a wireless network; a second step of reporting information on a communication device detected in the first step; a third step, if communication with a communication device reported in the second step is permitted or not permitted through an operation of operating means, of registering identification information of the communication device in a first table when the communication is permitted, and of registering the identification information of the communication device in a second table when the communication is not permitted; a fourth step of monitoring the wireless network and detecting a communication device constituting the wireless network whose identification information has not been registered in either the first table or the second table; a fifth step of warning of a suspected unauthorized access in addition to reporting information on a communication device detected in the fourth step; a sixth step, if communication with a communication device reported in the fifth step is permitted or not permitted through an operation of operating means, of registering identification information of the communication device in a first table additionally when the communication is permitted, and of registering the identification information of the communication device in a second table additionally when the communication is not permitted; and a seventh step of permitting communication with a communication device constituting the wireless network whose identification information has been registered in the first table, and of prohibiting communication with a communication device constituting the wireless network whose identification information has been registered in the second table or a communication device constituting the wireless network whose identification information has not been registered in either the first table or the second table.

The present invention also provides a wireless network comprising a plurality of communication devices and an access point, wherein: any one of the plurality of communication devices includes: detecting means for detecting a communication device constituting the wireless network; reporting means for reporting information of a communication device detected by the detecting means; operating means; first registering means, if communication with a communication device reported by the reporting means is permitted through an operation of the operating means, for registering identification information of the communication device in first memory; monitoring means for monitoring the wireless network and detecting a communication device constituting the wireless network whose identification information has not been registered in the first memory; warning means for warning of a suspected unauthorized access in addition to reporting information on a communication device detected by the monitoring means; updating means, if communication with a communication device reported by the warning means is permitted through an operation of the operating means, for registering identification information of the communication device in the first memory additionally; and informing means for informing the access point of identification information of a communication device, communication with which has not been permitted through an operation of the operating means, and the access point includes: relaying means for relaying communication between the plurality of communication devices constituting the wireless network; second registering means for registering identification information informed by the informing means in second memory; and prohibiting means for prohibiting communication with a communication device whose identification information has been registered in the second memory.

The wireless network may be configured to comprise a plurality of communication devices and an access point, wherein: any one of the plurality of communication devices includes: detecting means for detecting a communication device constituting a wireless network; reporting means for reporting information on a communication device detected by the detecting means; operating means; registering means, if communication with a communication device reported by the reporting means is permitted or not permitted through an operation of the operating means, for registering identification information of the communication device in a first table when the communication is permitted, and for registering the identification information of the communication device in a second table when the communication is not permitted; monitoring means for monitoring the wireless network and detecting a communication device constituting the wireless network whose identification information has not been registered in either the first table or the second table; warning means for warning of a suspected unauthorized access in addition to reporting information on a communication device detected by the monitoring means; updating means, if communication with a communication device reported by the warning means is permitted or not permitted through an operation of the operating means, for registering identification information of the communication device in a first table additionally when the communication is permitted, and for registering the identification information of the communication device in a second table additionally when the communication is not permitted; and communication controlling means for permitting communication with a communication device constituting the wireless network whose identification information has been registered in the first table, and for prohibiting communication with a communication device constituting the wireless network whose identification information has been registered in the second table or a communication device constituting the wireless network whose identification information has not been registered in either the first table or the second table, and the access point includes: relaying means for relaying communication between the plurality of communication devices constituting the wireless network; second registering means for registering identification information informed by the informing means in a third table; and prohibiting means for prohibiting communication with a communication device whose identification information has been registered in the third table.

### EFFECT OF INVENTION

According to the present invention, a communication device constituting a wireless network can register and update identification information easily, and thereby ensuring security of the communication device and the wireless network. Also, it becomes possible to detect a communication device suspected of accessing a wireless network illegally and to inform the user of the communication device.

### BRIEF DESCRIPTION OF THE DRAWINGS

FIG. 1 is a diagram illustrating a configuration of a wireless LAN 1 according to an embodiment of the present invention.

FIG. 2 is a block diagram illustrating a configuration of communication terminal 20b according to the embodiment.

FIG. 3 is a diagram illustrating each data configuration of permission table 206a and denial table 206b according to the embodiment.

FIG. 4 is a flowchart illustrating operations of an initial setting process performed in communication terminal 20b according to the embodiment.

FIG. 5 is a diagram illustrating an example of a first screen in the initial setting process according to the embodiment.

FIG. 6 is a diagram illustrating an example of a second screen in the initial setting process according to the embodiment.

FIG. 7 is a flowchart illustrating operations of a monitoring process performed in communication terminal 20b according to the embodiment.

FIG. 8 is a diagram illustrating an example of a screen in the monitoring process according to the embodiment.

FIG. 9 is a flowchart illustrating operations of a communication control process performed in communication terminal 20b according to the embodiment.

### BEST MODE FOR CARRYING OUT THE INVENTION

Below, with reference to the drawings, a preferred embodiment of the present invention will be described.

### A-1. Configuration of Embodiment

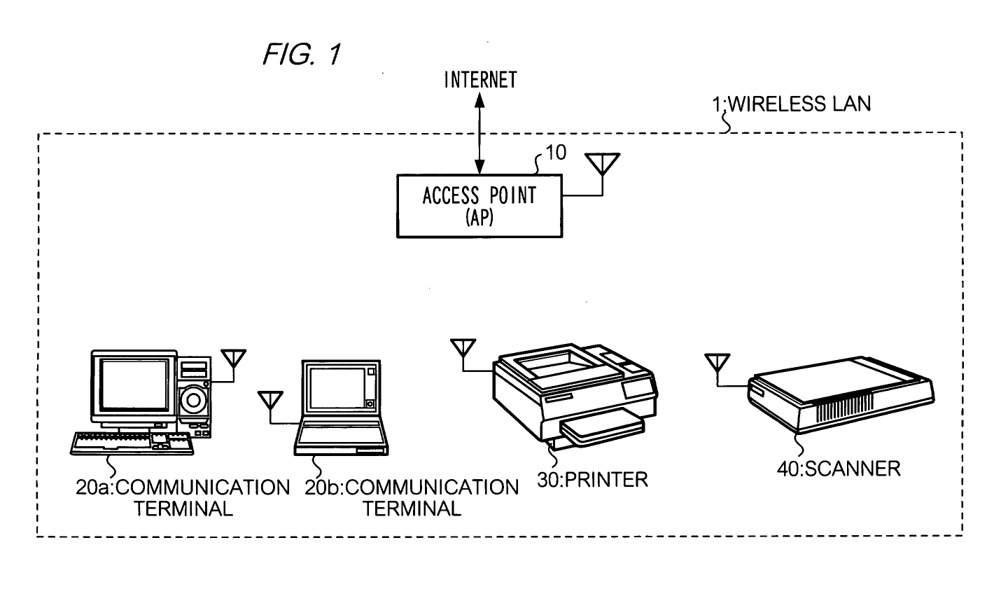

FIG. 1 is a diagram illustrating a configuration of wireless LAN 1 according to the present embodiment. The wireless LAN shown in the figure is for home use. Access point (hereinafter referred to as “AP”) 10 wirelessly communicates data with networked devices (“networked devices” refer to devices which are currently connected to a network) located in the wireless area covered by AP 10 such as communication terminals 20a and 20b, printer 30, and scanner 40. AP 10 also functions as a dialup router. AP 10, if receiving a connection request to the Internet from communication terminal 20b, accesses an Internet service provider via a public network, and connects communication terminal 20b to the Internet to relay communication. Communication terminals 20a and 20b are personal computers with a LAN card inserted. Printer 30 and scanner 40 have a function of communicating with AP 10 wirelessly and exchanging data with it as communication terminals 20a and 20b do.

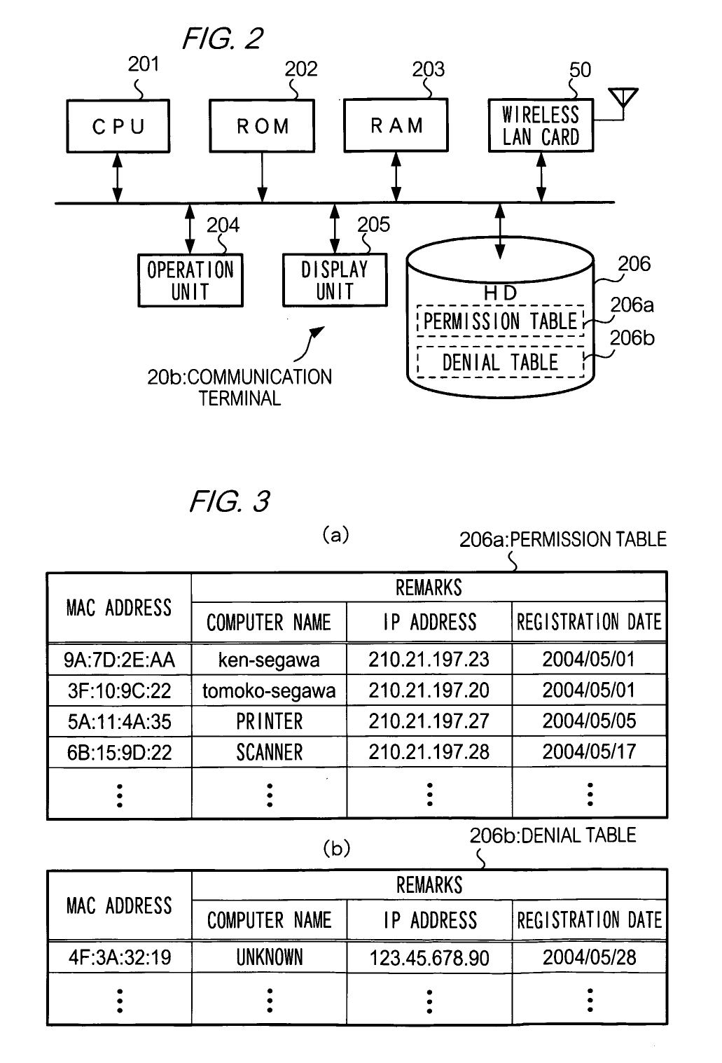

FIG. 2 is a block diagram illustrating a hardware configuration of communication terminal 20b. CPU 201 reads and executes a program stored in ROM 202 or HD (Hard Disk) 206, and thereby controls components of communication terminal 20b. ROM 202 stores programs for controlling communication terminal 20b. RAM 203 is used as a work area of CPU 201. Wireless LAN card 50 which is inserted into an expansion slot of communication terminal 20b, controls wireless communication with AP 10. Operation unit 204 consists of a keypad, a pointing device, etc. Display unit 205 consists of a liquid crystal display panel and a driving circuit for controlling a display of the liquid crystal display panel. Communication terminal 20b also has a clocking function.

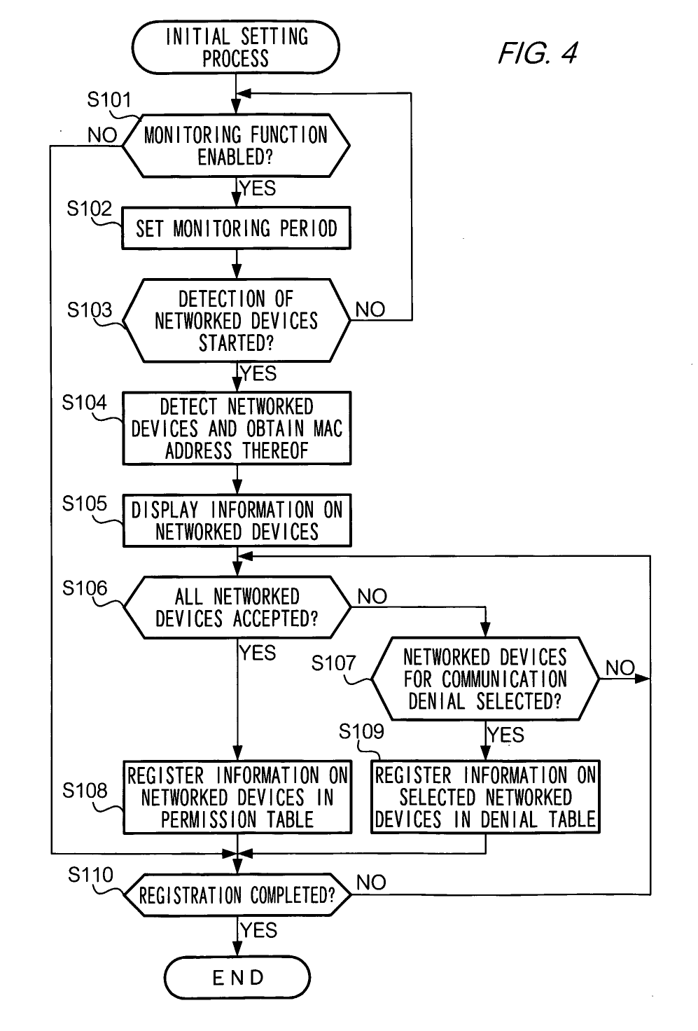

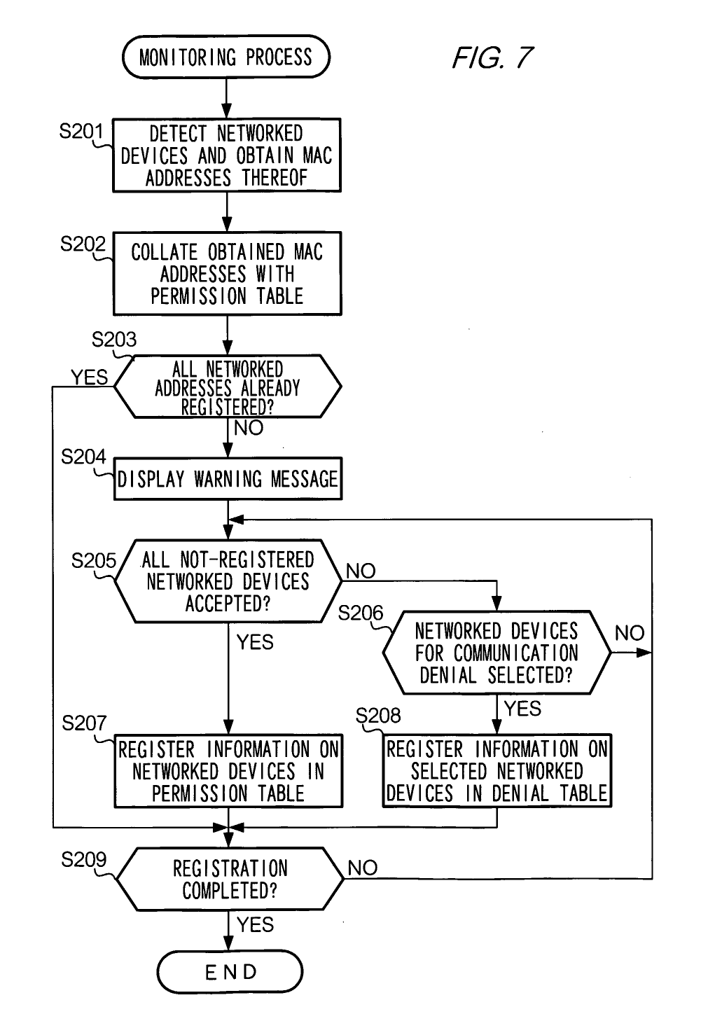

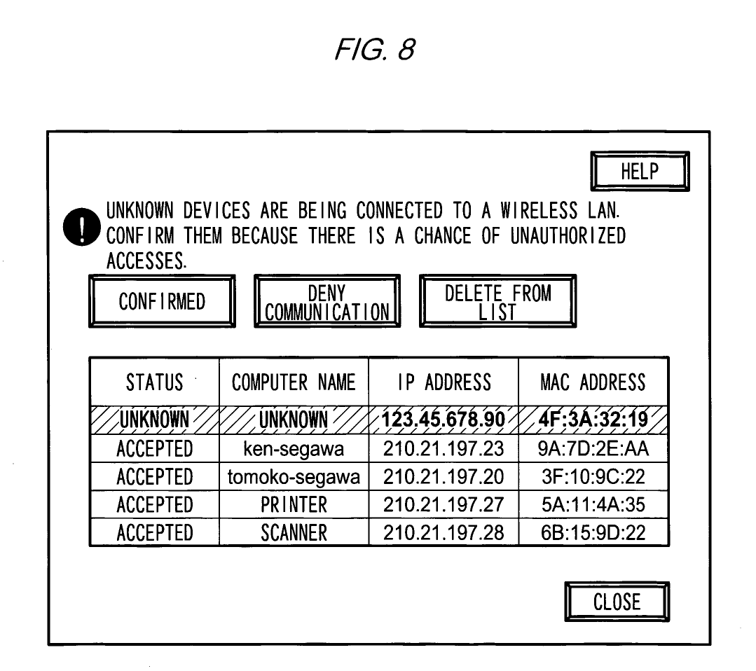

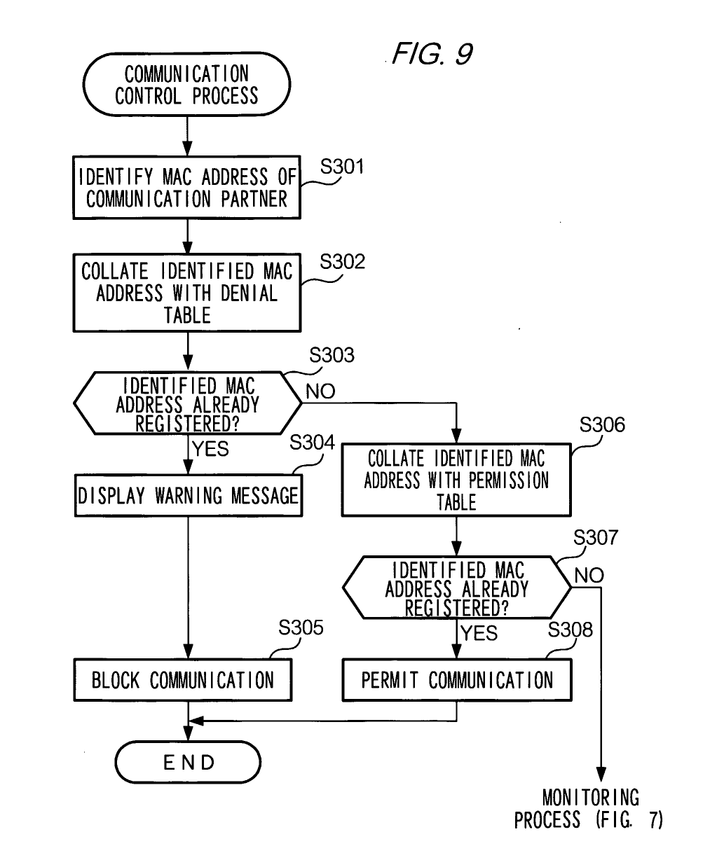

In HD 206, a security management program (application software) is installed. The program is used for an initial setting process (see FIG. 4), a monitoring process (see FIG. 7), and a communication control process (see FIG. 9), which are described later. HD 206 stores permission table 206a and denial table 206b. In permission table 206a, MAC addresses of network devices are registered, which are devices permitted by the user to communicate with communication terminal 20b among other network devices (e.g. communication terminal 20a, printer 30, and scanner 40) constituting wireless LAN 1. In denial table 206b, MAC addresses of network devices are registered, which are devices denied permission by the user to carry out communication with communication terminal 20b.

FIG. 3(a) is a diagram illustrating a data configuration of permission table 206a. As shown in the figure, in the remarks column, a computer name, an IP address, and a registration date of a network device permitted to carry out communication are entered. An IP address is assigned to a network device dynamically in wireless LAN 1. Accordingly, an IP address registered in permission table 206a is an IP address which has been assigned in the instance that communication terminal 20b obtains a MAC address of a network device. Similarly, a computer name registered in permission table 206a is also a computer name which has been assigned in the instance that communication terminal 20b obtains a MAC address of a network device.

FIG. 3(b) is a diagram illustrating a data configuration of denial table 206b. As shown in the figure, in the remarks column of denial table 206b, a computer name, an IP address, and a registration date of a network device, denied permission to carry out communication, are entered.

### A-2. Operation of Embodiment

FIG. 4 is a flowchart illustrating operations of an initial setting process performed in communication terminal 20b. The initial setting process is executed by CPU 201 when installation of a security management program into HD 206 is completed by the user. The security management program may be downloaded to communication terminal 20b from a server on the Internet via wireless LAN 1 and installed into HD 206. Also, the security management program may be distributed in the form of a storage medium such as a CD-ROM, and installed in HD 206 by being read from the storage medium using a reader such as a CD-ROM drive. Also, the security management program may be pre-installed in HD 206. In this case, when the security management program is launched at first, the initial setting process is performed.

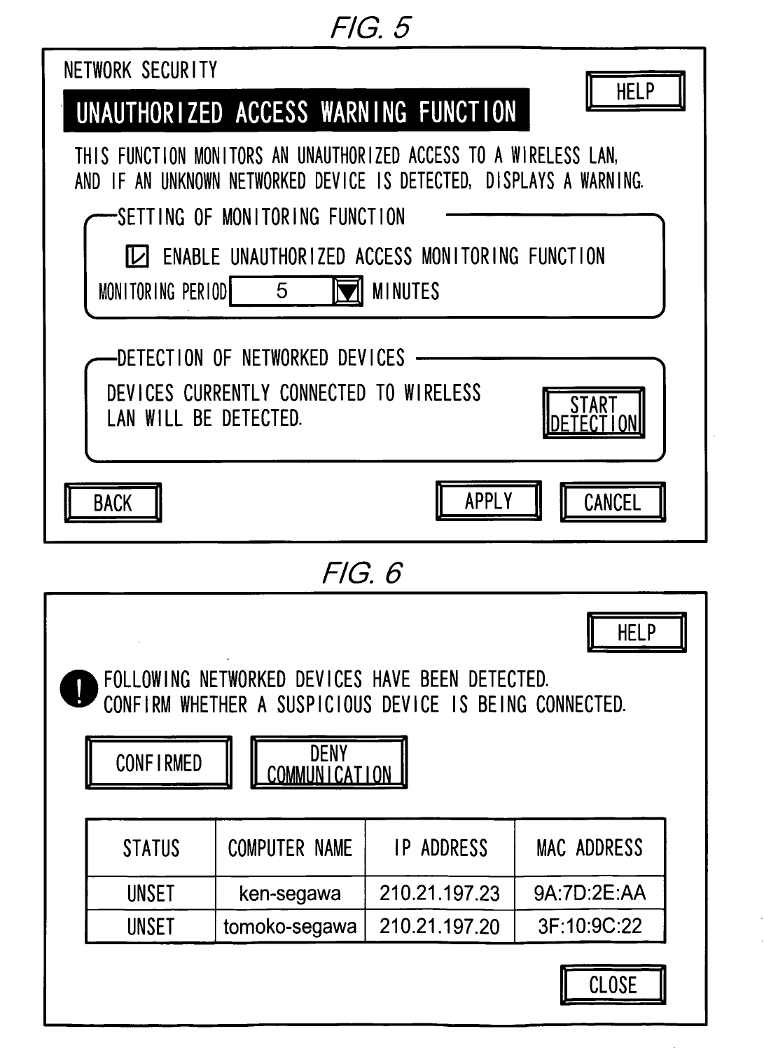

When the initial setting process is started, communication terminal 20b displays a main menu regarding the setting on a liquid crystal display panel (hereinafter referred to as “liquid crystal screen”) of display unit 205. When the user selects an unauthorized access warning function in the menu using a pointing device of operation unit 204, communication terminal 20b displays a menu screen as shown in FIG. 5. The unauthorized access warning function is, as shown in the figure, a function of monitoring an unauthorized access to wireless LAN 1, detecting an unknown networked device which has not been confirmed being as acceptable by the user, and warning the user of the presence of the networked device.

When the user enables an unauthorized access monitoring function by checking a check box for “Setting of Monitoring Function” of FIG. 5 (Step S101: YES), subsequently, communication terminal 20b sets a period of monitoring wireless LAN 1 (Step S102). Specifically, when the user selects a desired monitoring period from a period selection menu of FIG. 5, communication terminal 20b stores the selected monitoring period (five minutes in an example shown in FIG. 5) in HD 206. In the period selection menu, a plurality of monitoring periods are registered, which period is, for example, three minutes, five minutes, fifteen minutes, thirty minutes, sixty minutes, etc. The monitoring period, instead of being selected from the period selection menu, may be input directly with a keyboard.

When the user clicks “Start Detection” button of the item “Detection of Networked Devices” using the pointing device (Step S103: YES), communication terminal 20b detects devices which are currently connected to wireless LAN 1 (Step S104). Specifically, communication terminal 20b accesses AP 10 via wireless LAN card 50, broadcasts a message to all network devices located in the wireless area of AP 10, and detects all devices connected to wireless LAN 1 on the basis of the absence or presence of a reply message to the broadcast message.

The reply message contains a MAC address, a computer name, and an IP address of a replying networked device. Accordingly, in Step S104, when devices connected to wireless LAN 1 are detected, the MAC addresses of the detected devices are obtained.

Communication terminal 20b may identify the networked devices by making an inquiry at AP 10 about them.

Subsequently, communication terminal 20b displays information of the networked devices detected in Step S104 in the liquid crystal screen as shown in FIG. 6 (Step S105). In an example of FIG. 6, two computers named “ken-segawa” and “tomoko-segawa” are connected to wireless LAN 1 other than communication terminal 20b and AP 10. The user of communication terminal 20b, in accordance with a message as shown in the figure, determines whether the displayed networked devices are suspicious networked devices, and if the networked devices are acceptable, the user clicks the “Confirmed” button. On the other hand, if they includes a suspicious networked device, the user selects the suspicious networked device and clicks “Deny Communication” button.

If the “Confirmed” button is clicked, namely, the displayed networked devices are confirmed as being acceptable (Step S106: YES), communication terminal 20b registers in permission table 206 the MAC addresses, the computer names, and the IP addresses of the networked devices obtained in Step S104 (Step S108). Communication terminal 20b also registers a time and registration date in permission table 206a. For example, if the two computers named “ken-segawa” and “tomoko-segawa” of FIG. 6 are confirmed by the user as being acceptable, the MAC addresses, the computer names, and the IP addresses of the two computers are registered in permission table 206a.

On the other hand, if a suspicious networked device is selected on the menu screen of FIG. 6 and “Deny Communication” button is clicked (Step S107: YES), communication terminal 20b registers in denial table 206b the MAC address, the computer name, and the IP address of the selected networked device, namely, a networked device determined by the user as accessing illegally (Step S109). Communication terminal 20b also registers a time and a registration date in denial table 206b.

When registration of all the displayed networked devices is completed (Step S110: YES), communication terminal 20b concludes the initial setting process.

The initial setting process may be performed not only immediately after a security management program is installed or when a security management program is launched at first, but also at any given time in accordance with user's instructions. In this case, a user can change the enable/disable settings and a monitoring period of an unauthorized access monitoring function at any given time.

FIG. 7 is a flowchart illustrating operations of a monitoring process performed in communication terminal 20b. The monitoring process is performed by CPU 201 while communication terminal 20b is connected to wireless LAN 1 and in monitoring periods set in the initial setting process stated above.

As shown in the figure, communication terminal 20b detects at first devices currently connected to wireless LAN 1, and obtains the MAC addresses of the detected devices (Step S201). Since this Step S201 is similar to Step S104 stated above, specific explanation will be omitted. Mobile communication 20b collates the MAC addresses obtained in Step S201 with permission table 206b (Step S202), and thereby determines whether the MAC addresses have been registered (Step S203). If all the MAC addresses have been registered (Step S203: YES), communication terminal 20b determines that a device suspected of an unauthorized access is not currently connected to wireless LAN 1, and concludes the monitoring process.

On the other hand, if the MAC addresses obtained in Step S201 includes MAC addresses which have not been registered in permission table 206a (Step S203: NO), communication terminal 20b displays a warning screen as shown in FIG. 8 (Step S204). In an example shown in FIG. 8, other than the four network devices which have been pre-confirmed as being acceptable by the user (computers named “ken-segawa”, “tomoko-segawa”, “printer”, and “scanner”), a network device (MAC address “4F:3A:32:19”) which has not been confirmed by the user is connected to wireless LAN 1.

The networked device (MAC address “4F:3A:32:19”) may not necessarily be a network device illegally accessing, because it may be an acceptable network device which has been added to wireless LAN 1 by the user. Accordingly, the user of communication terminal 20b, in accordance with a message shown in FIG. 8, determines whether the networked device is a suspicious one. If the networked device is acceptable, the user clicks the “Confirmed” button, and if not, the user clicks the “Deny Communication” button.

If the “Confirmed” button is clicked, namely, the networked device is confirmed as being acceptable (Step S205: YES), communication terminal 20b registers in permission table 206 the MAC address, the computer name, and the IP address of the networked device additionally (Step S207). On the other hand, if the “Deny Communication” button is clicked, namely, the networked device is determined to be accessing illegally (Step S206: YES), communication terminal 20b registers in denial table 206b the MAC address, the computer name, and the IP address of the networked device additionally (Step S208). In both cases, a registration date is also registered.

When registration of all necessary information on the displayed networked device is completed (Step S209: YES), communication terminal concludes the monitoring process.

“Delete from List” button on the menu screen of FIG. 8 is used when a user removes a hitherto used networked device from wireless LAN 1 or when a user deletes information mistakenly registered in permission table 206a or denial table 206b.

In the monitoring process, communication terminal 20b may display only a warning message when detecting a networked device whose MAC address has not been registered in either permission table 206a or denial table 206b. With the configuration, a warning message is displayed only when an unknown networked device which is yet to be confirmed by the user is detected.

FIG. 9 is a flowchart illustrating operations of a communication control process performed in communication terminal 20b. The communication control process is performed by CPU 201 when communication terminal 20b starts to communicate with another networked device on wireless LAN 1.

As shown in the figure, at first, communication terminal 20b identifies a MAC address of a networked device with which communication terminal 20b will communicate (Step S301). When the MAC address is identified, communication terminal 20b collates the MAC address with denial table 206b (Step S302), and thereby determines whether the MAC address has been registered in denial table 206b (Step S303). As a result, if the MAC address has been registered (Step S303: YES), communication terminal 20b displays a warning message showing that the networked device is a suspicious networked device which is set by the user as being denied permission to carryout communication (Step S304), and blocks communication with the networked device (Step S305).

On the other hand, if the MAC address identified in Step S301 has not been registered in denial table 206b (Step S303: NO), communication terminal 20b collates the MAC address with permission table 206a (Step S306), and thereby determines whether the MAC address has been registered in permission table 206a (Step S307). As a result, if the MAC address has been registered in permission table 206a (Step S307: YES), communication terminal 20b starts the communication with the networked device (Step S308).

If the MAC address has not been registered in permission table 206a (Step S307: NO), which means that the networked device is an unknown networked device whose MAC address has not been registered either in denial table 206b or permission table 206a, communication terminal 20b moves to the monitoring process stated above, and displays a warning about the networked device and registers the MAC address thereof in either permission table 206a or denial table 206b additionally.

As described above, according to the present embodiment, communication terminal 20b detects and reports networked devices constituting wireless LAN 1, and if communication with the reported networked devices are permitted through an operation of operating unit 204, registers the MAC addresses of the networked devices in permission table 206a. Also, communication terminal 20b monitors wireless LAN 1, detects an unknown networked device whose MAC address has not been registered in permission table 206a, and warns of a suspected unauthorized access. If communication with the detected networked device is permitted, communication terminal 20b registers the MAC address of the networked device in permission table 206a additionally. Also, communication terminal 20b permits communication to be carried out with a networked device constituting wireless LAN 1 whose MAC address has been registered in permission table 206a, and prohibits the carrying out of communication with a networked device constituting wireless LAN 1 whose MAC address has not been registered in permission table 206a.

As described above, since a networked device which has not been confirmed as being acceptable by a user is reported to the user, by performing a registration operation of the reported networked device each time, registration and update operations of MAC addresses which are necessary for preventing an unauthorized access are fulfilled. Accordingly, even a user having no technical knowledge of a wireless LAN can register and update MAC addresses easily. Also, failure to perform registration and update operations of MAC addresses by the user because of forgetfulness can be ruled out.

According to the configuration stated above, in addition to preventing an unauthorized access against communication terminal 20b such as breaking into a wireless LAN for stealing data stored in networked devices, registration and update of MAC addresses in permission table 206a can be fully achieved. Also, a networked device suspected of illegally accessing on wireless LAN 1 is detected, and a warning message regarding the networked device is transmitted to a user.

### B. Modifications

(1) In the above embodiment, a networked device whose MAC address is registered in denial table 206b may also be registered in AP 10. Specifically, communication 20b, after Steps S109 and S208, informs AP 10 of a networked device whose MAC address has been registered in denial table 206b, and AP 10 registers the received MAC address in a communication denial table thereof. From then on, AP 10 prohibits communication with the communication terminal whose MAC address was registered in the communication denial table.

With the configuration, it becomes possible to prevent not only an authorized access against communication terminal 20b, but also an unauthorized access against wireless LAN 1 such as stealing data exchanged on wireless LAN 1 or accessing another communication network via invaded wireless LAN 1, and consequently security of wireless LAN 1 is ensured. The communication denial table may be stored in a storage device provided outside of AP 10.

(2) In the above embodiment, when a networked device whose MAC address has not been registered in permission table 206a is detected, communication terminal 20b may be configured to warn a user of a suspected unauthorized access if the detected networked device continues communication on wireless LAN 1 longer than a predetermined time period. Specifically, communication terminal 20b, when detecting a networked device whose MAC address has not been registered in permission table 206a, measures a time period when the networked device continues communication on wireless LAN 1. Communication terminal 20b, if the measured time period exceeds a predetermined time period (e.g. five minutes), reports to the user the networked device as being a networked device suspected of illegally accessing. The configuration is advantageous for a public wireless LAN where there is a large turnover of served communication terminals, because it is cumbersome, as shown in FIG. 8, to display a warning message each time a new communication terminal connects to the public wireless LAN.

In the above embodiment, a warning of a networked device suspected of illegally accessing may be reported by a voice message, instead of being displayed on a screen. Alternatively, information on a networked device suspected of illegally accessing may be printed on a paper and outputted.

(3) In the above embodiment, instead of a MAC address, an identification code which is assigned by communication terminal 20b to each networked device may be used as identification information of a networked device.

In the above embodiment, a monitoring process (see FIG. 7) may be performed when communication terminal 20b starts to communicate with AP 10, instead of at regular intervals.

In the above embodiment, permission table 206a and denial table 206b may be stored in a storage device outside of communication terminal 20b.

(4) In the above embodiment, communication terminals 20a and 20b may be a PDA with a wireless communication function, instead of a personal computer with wireless LAN card 50 inserted.

In the above embodiment, wireless LAN 1 may be used for office use or applied to a public wireless LAN, instead of for home use.

1. A communication device comprising:
detecting means for detecting a communication device constituting a wireless network;
reporting means for reporting information on a communication device detected by the detecting means;
operating means;
registering means, if communication with a communication device reported by the reporting means is permitted through an operation of the operating means, for registering identification information of the communication device in memory;
monitoring means for monitoring the wireless network and detecting a communication device constituting the wireless network whose identification information has not been registered in the memory;
warning means for warning of a suspected unauthorized access in addition to reporting information on a communication device detected by the monitoring means;
updating means, if communication with a communication device reported by the warning means is permitted through an operation of the operating means, for registering identification information on the communication device in the memory additionally; and
communication controlling means for permitting communication with a communication device constituting the wireless network whose identification information has been registered in the memory, and for prohibiting communication with a communication device constituting the wireless network whose identification information has not been registered in the memory.

2. A communication device according to claim 1, further comprising setting means for setting a monitoring period of the wireless network, wherein the monitoring means monitors the wireless network during monitoring periods set by the setting means and detects a communication device constituting the wireless network whose identification information has not been registered in the memory.

3. A communication device according to claim 1, further comprising time measuring means, if a communication device whose identification information has not been registered in the memory is detected by the monitoring means, for measuring a time period when the communication device continues a wireless communication in the wireless network, wherein the warning means, if a time period measured by the time measuring means exceeds a predetermined time period, warns of a suspected unauthorized access in addition to reporting information on a communication device detected by the monitoring means.

4. A communication device comprising:
detecting means for detecting a communication device constituting a wireless network;
reporting means for reporting information on a communication device detected by the detecting means;
operating means;
registering means, if communication with a communication device reported by the reporting means is permitted or not permitted through an operation of the operating means, for registering identification information of the communication device in a first table when the communication is permitted, and for registering the identification information of the communication device in a second table when the communication is not permitted;
monitoring means for monitoring the wireless network and detecting a communication device constituting the wireless network whose identification information has not been registered in either the first table or the second table;
warning means for warning of a suspected unauthorized access in addition to reporting information on a communication device detected by the monitoring means;
updating means, if communication with a communication device reported by the warning means is permitted or not permitted through an operation of the operating means, for registering identification information of the communication device in a first table additionally when the communication is permitted, and for registering the identification information of the communication device in a second table additionally when the communication is not permitted; and
communication controlling means for permitting communication with a communication device constituting the wireless network whose identification information has been registered in the first table, and for prohibiting communication with a communication device constituting the wireless network whose identification information has been registered in the second table or a communication device constituting the wireless network whose identification information has not been registered in either the first table or the second table.

5. A wireless network comprising a plurality of communication devices and an access point, wherein:
any one of the plurality of communication devices includes:
detecting means for detecting a communication device constituting the wireless network;
reporting means for reporting information of a communication device detected by the detecting means;
operating means;
first registering means, if communication with a communication device reported by the reporting means is permitted through an operation of the operating means, for registering identification information of the communication device in first memory;
monitoring means for monitoring the wireless network and detecting a communication device constituting the wireless network whose identification information has not been registered in the first memory;
warning means for warning of a suspected unauthorized access in addition to reporting information on a communication device detected by the monitoring means;
updating means, if communication with a communication device reported by the warning means is permitted through an operation of the operating means, for registering identification information of the communication device in the first memory additionally; and
informing means for informing the access point of identification information of a communication device, communication with which has not been permitted through an operation of the operating means, and
the access point includes:
relaying means for relaying communication between the plurality of communication devices constituting the wireless network;
second registering means for registering identification information informed by the informing means in second memory; and
prohibiting means for prohibiting communication with a communication device whose identification information has been registered in the second memory.

6. A program for causing a computer to execute:
a first step of detecting a communication device constituting a wireless network;
a second step of reporting information of a communication device detected in the first step;
a third step, if communication with a communication device reported in the second step is permitted through an operation of operating means, of registering identification information of the communication device in memory;
a fourth step of monitoring the wireless network and detecting a communication device constituting the wireless network whose identification information has not been registered in the memory;
a fifth step of warning of a suspected unauthorized access in addition to reporting information on a communication device detected in the fourth step;
a sixth step, if communication with a communication device reported in the fifth step is permitted through an operation of the operating means, of registering identification information of the communication device in the memory additionally; and
a seventh step of permitting communication with a communication device constituting the wireless network whose identification information has been registered in the memory, and of prohibiting communication with a communication device constituting the wireless network whose identification information has not been registered in the memory.

7. A computer-readable storage medium recording a program according to claim 6.
